(19) United States
(12) Patent Application Publication
(10) Pub. No.: US 2025/0319742 A1
(43) Pub. Date: Oct. 16, 2025

(54) GLAZED ELEMENT COMPRISING A CONDENSATION DETECTOR

(71) Applicant: SAINT-GOBAIN GLASS FRANCE, COURBEVOIE (FR)

(72) Inventor: David CHAUVIN, AUBERVILLIERS (FR)

(21) Appl. No.: 18/869,963

(22) PCT Filed: May 31, 2023
(86) PCT No.: PCT/EP2023/064532

§ 371 Date: Nov. 27, 2024

(30) Foreign Application Priority Data
May 31, 2022 (FR) 2205222

(51) Int. Cl. B60H 1/00; B60J 1/02; B60J 1/20

(52) U.S. Cl. CPC B60H 1/00785; B60J 1/02; B60J 1/20

(57) ABSTRACT

A glazed element includes a glazed unit including a first glass sheet, the first glass sheet having a first face and a second face, the glazed unit having a first edge and a second edge opposite the first edge, the glazed element including a light source configured to emit a light beam, and a photodetector configured to detect the light beam emitted by the light source, the light source being arranged so that the light beam propagates in the first glass sheet from the first edge toward the second edge by several total internal reflections on the first face and on the second face, the photodetector being arranged outside the glazed unit and on the side of the first face relative to the first glass sheet, the photodetector being configured to receive the light beam passing through at least a part of the detection surface.

### FIELD OF THE INVENTION

The present invention relates to a glazed element for a vehicle, comprising a condensation detector.

### STATE OF THE ART

During the appearance of condensation droplets on the internal face of a glazed unit of a vehicle, it is known to manually activate an ambient temperature and/or ventilation regulator in the vehicle, so as to control the evaporation of the condensation droplets.

However, this method can distract the driver of the vehicle. Furthermore, this method is only possible when the condensation droplets have already appeared and have already impaired the visual perception of the driver through the glazed unit.

To this end, document EP 3 552 004 describes a capacitive condensation sensor comprising interdigital electrodes inserted into a glazed unit. During the formation of the condensation on the internal face of the glazed unit, the capacity measured by the sensor varies. Thus, it is possible to dispense with visual detection of the condensation, and thus reduce the driver's loss of concentration.

However, the sensor disclosed in document EP 3 552 004 does not make it possible to detect the smallest droplets of condensation. Thus, it is possible that the condensation can be perceptible by the driver before it is detected by the capacitive sensor.

Furthermore, the capacitive detection of the condensation can have a latency of the order of about ten seconds. For example, it is known that the condensation sensor comprises a material capable of absorbing the water of a condensation droplet. In this case, the electrical capacity of this material is measured by the sensor and the latency of the sensor can depend on the water absorption kinetics of the material. This latency may be sufficient for a condensation density to increase and consequently impair the visual perception of the driver.

### OVERVIEW OF THE INVENTION

One purpose of the invention is to propose a solution for automatically detecting condensation on the surface of a glazed unit of a vehicle, and preferably before it is perceptible by the driver.

This aim is achieved in the context of the present invention by means of a glazed element for a vehicle, comprising a glazed unit extending along a main surface, the glazed unit comprising a first glass sheet, the first glass sheet having a first face and a second face, preferentially parallel to the main surface, the second face being opposite the first face relative to the first glass sheet, the glazed unit having a first edge and a second edge opposite the first edge, the first face being able to be in contact with an interior environment of the vehicle and to support the nucleation of a condensation droplet,

the glazed element comprising a light source configured to emit a light beam, and a photodetector configured to detect the light beam emitted by the light source, the light source being arranged so that the light beam propagates in the first glass sheet from the first edge toward the second edge by several total internal reflections on the first face and on the second face,

the photodetector being arranged outside the glazed unit and on the side of the first face relative to the first glass sheet,

the first face comprising a detection surface having a surface area greater than 0.01% inclusive of a total surface area of the first face, in particular greater than 1% inclusive of a total surface area of the first face and preferentially greater than 20% inclusive of a total surface area of the first face,

the photodetector being configured to receive the light beam passing through at least a part of the detection surface.

The present invention is advantageously completed by the following features, taken individually or in any of their technically possible combinations:
the glazed unit is a laminated glazed unit, the glazed unit comprising a second glass sheet and an interlayer arranged between the first glass sheet and the second glass sheet, the second face being on the side of the interlayer relative to the first glass sheet, the first glass sheet being formed by a first glass having a first refractive index n₁, the glazed unit comprising a first material covering the second face on the side of the interlayer relative to the second face and having a second refractive index n₂, the second refractive index n₂ being strictly less than the first refractive index n₁,
the first material covering the second face forms, at least in part, the interlayer,
the first glass has a first absorption coefficient a₁ of the light beam, the second glass sheet being formed by a second glass, the second glass having a second absorption coefficient a₂ of the light beam, the first absorption coefficient a₁ being strictly less than the second absorption coefficient a₂, the first absorption coefficient a₁ being preferentially less than 0.5 cm⁻¹, in particular less than 0.1 cm⁻¹.
the light source extends along the first edge, preferentially from one corner of the glazed unit, in particular to another corner of the glazed unit,
the light beam has a wavelength of between 780 nm inclusive and 2500 nm inclusive, in particular between 800 nm and 1100 nm inclusive, and preferentially between 900 nm inclusive and 1000 nm inclusive,
the detection surface is defined by a part of the first face, the part running along an element chosen from a lateral edge of the glazed unit, a lateral edge on the driver's side of the glazed unit, a lower lateral edge of the glazed unit, a corner of the glazed unit and a lower corner on the driver's side of the glazed unit,
the photodetector has no filter configured to transmit a light beam having a wavelength only between 380 nm inclusive and 780 nm inclusive,
the photodetector has a field of view, the arrangement of the photodetector and the field of view being configured so that the photodetector detects a light beam passing through the detection surface,
the first edge is the conductive side edge of the glazed unit,
the glazed element comprises a housing configured to support a rearview mirror of the vehicle, the photodetector being arranged in the housing,
the glazed unit comprises a light absorption layer arranged on part of the first face, the light absorption layer forming a pattern on the first face, the light absorption layer having a transmittance greater than 0.7, preferentially greater than 0.9, for a wavelength range of between 380 nm inclusive and 780 nm inclusive, and having a transmittance of less than 0.3, preferentially less than 0.1, for a wavelength range of between 780 nm exclusive and 1100 nm inclusive,
the light absorption layer is formed by a second material, the second material being an electrically conductive and/or electrically semiconductive oxide, the second material preferably being indium-tin oxide,
parts of the pattern have a width relative to the main surface of less than 1 cm, preferably less than 5 mm,
the pattern forms an array of strips on the detection surface, the strips preferentially being parallel to one another,
the second material is indium-tin oxide doped with at least one metal element and configured to have maximum light absorption for a wavelength between 780 nm and 1000 nm.

### DESCRIPTION OF THE FIGURES

Other features, purposes and advantages of the invention will emerge from the following description, which is purely illustrative and non-limiting, and which must be read in conjunction with the appended drawings, in which:

FIG. 1 schematically shows a glazed element according to one embodiment of the invention,

FIG. 2 schematically shows a cross-section of a glazed element according to one embodiment of the invention,

FIG. 3 schematically shows a glazed element according to one embodiment of the invention,

FIG. 4 schematically shows a pattern formed by a layer deposited on a first face of the glazed unit,

FIG. 5 schematically shows a measurement of the intensity detected in the absence of condensation,

FIG. 6 schematically shows a measurement of the intensity detected when condensation is present on the first face.

FIG. 7 shows the absorption of materials from a light absorption layer as a function of the wavelength of an incident light beam.

In all the figures, similar elements are marked with identical references.

### DEFINITIONS

“Glazed unit” is understood to mean a structure comprising at least one sheet of organic or mineral glass, suitable for being mounted in a vehicle. “Laminated glazed unit” is understood to mean a glazed assembly comprising at least two glass sheets and an interlayer made of plastic material, preferentially viscoelastic, separating the two glass sheets. The interlayer may comprise one or several viscoelastic polymer layers, for example of polyvinyl butyral (PVB) or ethylene-vinyl acetate copolymer (EVA). The interlayer film is preferably standard PVB or acoustic PVB. Acoustic PVB can comprise three layers: two outer layers of standard PVB and an inner layer of PVB comprising a plasticizer so as to make the inner layer less rigid than the outer layers.

It is understood that a refractive index is greater than another refractive index for a predetermined wavelength, preferentially for the wavelength(s) of the light beam emitted by the light source.

“Transmittance” of a layer is understood to mean the transmittance of the layer measured for an incident light beam in a direction normal to the main plane according to which a glazed unit extends. Transmittance is defined by the ratio of the intensity of the light beam transmitted by the layer and the intensity of the light beam incident to the layer.

The glazed unit of the glazed element according to all of the embodiments of the invention has a shape and geometry configured to be mounted on a vehicle according to a predetermined single position. Thus, it is possible to define, relative to this predetermined position, a lateral edge on the driver's side of the glazed unit, a lateral edge on the passenger's side of the glazed unit, an upper lateral edge of the glazed unit and a lower lateral edge of the glazed unit. In the same way, it is possible to define, relative to this predetermined position, an upper corner on the driver's side of the glazed unit, an upper corner of the passenger's side of the glazed unit, a lower corner on the driver's side of the glazed unit, and a lower corner on the passenger's side of the glazed unit.

“Driver's side edge” of the glazed unit is understood as the lateral edge of the glazed unit on the driver's side when the glazed unit is mounted on the vehicle according to a single position predetermined by the shape and geometry of the glazed unit.

“Passenger's side edge” of a glazed unit is understood to mean the lateral edge of the glazed unit positioned on the passenger's side, opposite the driver's side, when the glazed unit is mounted on the vehicle according to a single position predetermined by the shape and geometry of the glazed unit.

“Upper lateral edge” of a glazed unit is understood to mean the lateral edge of the glazed unit positioned on the upper part of the glazed unit, when the glazed unit is mounted on the vehicle according to a single position predetermined by the shape and geometry of the glazed unit.

“Lower lateral edge” of a glazed unit is understood to mean the lateral edge of the glazed unit positioned on the lower part of the glazed unit when the glazed unit is mounted on the vehicle according to a single position predetermined by the shape and geometry of the glazed unit.

“Driver's side upper corner” of a glazed unit is understood to mean the corner of the glazed unit positioned on the upper part of the glazed unit on the driver's side, when the glazed unit is mounted on the vehicle according to a single position predetermined by the shape and geometry of the glazed unit.

“Driver's side lower corner” of a glazed unit is understood to mean the corner of the glazed unit positioned on the lower part of the glazed unit on the driver's side, when the glazed unit is mounted on the vehicle according to a single position predetermined by the shape and geometry of the glazed unit.

“Visible wavelength” is understood to be a wavelength of between 380 nm and 780 nm.

### DETAILED DESCRIPTION OF THE INVENTION

### General Architecture of the Glazed Element 1

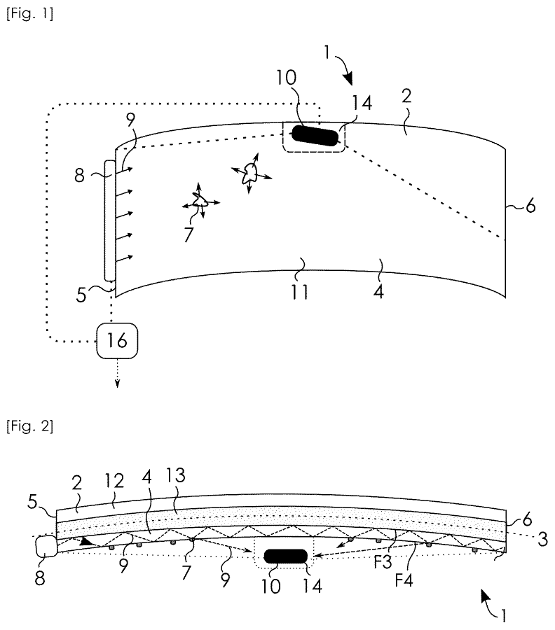

With reference to FIG. 1 and to FIG. 2, one aspect of the invention is a glazed element 1 for a vehicle. The glazed element 1 comprises a glazed unit 2. The glazed unit 2 extends along a main surface 3. The glazed unit 2 comprises a first glass sheet 4. The first glass sheet 4 has a first face F4 and a second face F3. The first face F4 and the second face F3 can be parallel to the main surface 3. The second face F3 is opposite the first face 4 relative to the first glass sheet 4.

The glazed unit 2 has a first edge 5 and a second edge 6 opposite the first edge 5. The first face F4 is adapted to be in contact with an interior environment of the vehicle. The geometry of the glazed element 1 can be configured so that, when the glazed element 1 is mounted in the vehicle, the first face F4 is inside the vehicle. The first edge 8 and the second edge 9 can be lateral edges on the driver's and the passenger's side, which are able to extend along at least vertical component when the glazed element 1 is mounted in the vehicle. The geometry of the glazed element 1 can be configured so that, when the glazed element 1 is mounted in the vehicle, the first edge 5 is on the passenger's side of the vehicle. The first face F4 is able to support the nucleation of a condensation droplet 7.

The glazed element 1 comprises a light source 8. The light source 8 is configured to emit a light beam 9. The glazed element 1 comprises a photodetector 10 configured to detect the light beam 9 emitted by the light source 8. The light source 8 is arranged so that the light beam 9 propagates through the first glass sheet 4 from the first edge 5 to the second edge 6 by several total internal reflections on the first face F4 and on the second face F3.

The first face F4 separates the glazed unit 2 from ambient air. Thus, a total internal reflection of the light beam 9 in the first glass sheet 4 on the first face F4 is possible.

The second face F3 can separate the glazed unit from the ambient air. As a variant, the glazed unit 2 may be a laminated glazed unit. Thus, a total internal reflection of the light beam 9 in the first glass sheet 4 on the second face F3 is possible.

The glazed unit 2 may comprise a second glass sheet 12 and an interlayer 13 arranged between the first glass sheet 4 and the second glass sheet 12. The second face F3 is on the side of the interlayer 13 relative to the first glass sheet 4. The first glass sheet 4 is formed by a first glass having a first refractive index n₁. The glazed unit 2 may comprise a first material covering the second face F3 on the side of the interlayer 13 relative to the second face F3 and having a second refractive index n₂. The second refractive index n₂ is strictly less than the first refractive index n₁. Thus, a total internal reflection of the light beam 9 in the first glass sheet 4 on the second face F3 is possible.

The first material covering the second face F3 can form, at least in part, the interlayer 13. The material covering the second face F3 may be a PVB forming the interlayer 13. Thus, the manufacture of the waveguide formed by the first glass sheet 4 is simplified, since it is not necessary to modify the structure of the laminated glazed unit 2 in order to use the first glass sheet 4 as waveguide. Indeed, the PVB has a refractive index less than the refractive index of the glass for wavelengths in the visible and infrared range.

The photodetector 10 is arranged outside the glazed unit 2 and on the side of the first face F4 relative to the first glass sheet 4. The first face F4 comprises a detection surface 11 having a surface area greater than 0.01% inclusive of a total surface area of the first face F4, in particular greater than 0.1% inclusive of a total surface area of the first face F4, preferentially greater than 20% inclusive of a total surface area of the first face F4, preferentially greater than 50% inclusive of a total surface area of the first face F4, and preferentially greater than 70% inclusive of a total surface area of the first face F4.

The photodetector 10 is configured to detect the light beam 9 passing through at least part of the detection surface 11, from the first glass sheet 4 toward the photodetector 10. Thus, the first glass sheet 4 forms a waveguide on which condensation droplets can be formed. Indeed, due to the relationship between the refractive indices of the air and/or the first material in contact with the first glass sheet 4, the light beam 9 can propagate from the light source 8 to the photodetector 10 by total internal reflections on the first face F4 and on the second face F3. During the nucleation of a condensation droplet 7 on the first face F4, part of the light beam 9 is transmitted to the interface formed between the glass and the first glass sheet 4 and the liquid water of the condensation droplet 7. Thus, the photodetector 10 can detect the presence of one or more condensation droplets 7 over the entire detection surface 11 for a predetermined detection surface 11. Indeed, the inventors have discovered that the condensation droplets 7 preferentially form at predetermined locations of the first face F4, these locations forming the detection surface 11. The glazed element 1 thus makes it possible to detect the presence of condensation droplets 7 on the first face F4 early, before the condensation droplets 7 are visually detectable by the driver of the vehicle.

The glazed element 1 may comprise a control unit 16 configured for:
controlling an emission of the light beam 9 by the light source 8,
receiving data representative of the light beam 9 detected by the photodetector 10,
comparing the data representative of the light beam 9 detected by the photodetector 10 with data representative of a reference light beam, and emitting a signal representative of the nucleation of a condensation droplet from the comparison.

As a variant, the control, reception, comparison and emission steps described above can be implemented by a control unit of the vehicle's engine.

### Detection Surface 11

The detection surface 11 can be defined by at least a part of the first face F4, the part running along at least one element chosen from a lateral edge of the glazed unit, a lateral edge on the driver's side of the glazed unit, a lower lateral edge of the glazed unit, a corner of the glazed unit and a lower corner on the driver's side of the glazed unit.

Indeed, the inventors have discovered that the parts of the first face F4 described above are able to support the nucleation of condensation droplets 7 before the nucleation of the condensation droplets 7 on the other parts of the first face F4. Thus, it is possible to detect the nucleation of the condensation droplets 7 before they are visually detectable by the driver of the vehicle on the rest of the first surface F4.

### Light Absorption of Glass Sheets

The first glass can have a first absorption coefficient a₁ of the light beam

9. The second glass sheet 12 may be formed by a second glass. The second glass can have a second absorption coefficient a₂ of the light beam 9. The first absorption coefficient a₁ can be strictly less than the second absorption coefficient a₂. Thus, the glazed unit 2 can have absorption properties of the infrared radiation in transmission while allowing the detection of the nucleation of a condensation droplet on the first face F4.

The first absorption coefficient a₁ can be less than 0.5 cm⁻¹, and preferably less than 0.1 cm⁻¹. Thus, it is possible to limit the absorption of the light beam 9 during its propagation in the first glass sheet 4 in order to detect the condensation, while allowing the glazed unit 2 to absorb the infrared radiation. The second absorption coefficient a₂ can be greater than 2 cm⁻¹ and preferentially greater than 3 cm⁻¹.

### Light Source 8

The light source 8 can extend along the first edge 5, preferentially from one corner of the glazed unit 2, in particular to another corner of the glazed unit 2. The light source 8 can emit light beams 9 along the first edge 5 toward the second edge 6. Thus, the parts of the detection surface 11 on which the condensation droplets 7 appear first benefit from a light beam 9 that is less attenuated by the first glass than when it arrives at the second edge 6. This makes it possible to maximize the light intensity received by the photodetector 10 in order to detect a condensation droplet 7. The first edge 5 may be the driver's side edge of the glazed unit 2. Thus, it is possible to detect the nucleation of condensation droplets 7 before the nucleation of other condensation droplets 7 on the rest of the first face F4.

The light source 8 may be configured to emit a light beam 9 having one or several wavelengths selected from a range of wavelengths between 800 nm and 2500 nm. Thus, it is possible to increase the total internal reflection properties of the waveguide formed by the first glass sheet 4 while using a light beam 9 which is not visible to the vehicle user.

The light source 8 may be configured to emit a light beam 9 having one or several wavelengths selected from a range of wavelengths between 800 nm and 1100 nm. Thus, in addition to the advantages described above for a wavelength range of between 800 nm and 2500 nm, a wavelength range of between 800 nm and 1100 nm makes it possible to detect the light beam 9 using a conventional photodetector 10 configured to detect light beams having a wavelength within the visible wavelength range. Indeed, this type of photodetector primarily makes it possible to detect wavelengths in the near infrared, that is, in the wavelength range of between 800 nm and 1100 nm.

This results in simplifying the manufacture of the glazed element 1 and reducing the costs related to this manufacturing.

The light source 8 may be formed by a bar comprising a series of LEDs. The bar can be mounted in contact with the first edge 5 and/or the second edge 6.

### Photodetector 10

The photodetector 10 is arranged outside the glazed unit 2 so as to detect and/or image a light beam 9 coming from the detection surface 11, and preferably from all points forming the detection surface 11. The photodetector 10 has a field of view. The arrangement of the photodetector 10 and the field of view are configured so that the photodetector 10 detects a light beam passing through the detection surface 11.

The photodetector 10 may be a photodetector configured to detect a light beam 9 having a wavelength within the visible wavelength range. Indeed, this type of photodetector mainly makes it possible to also detect wavelengths within a wavelength range in the near infrared, preferably between 800 nm and 1100 nm. Thus, it is possible to simplify the manufacture of the glazed element 1 and to reduce the costs associated with this manufacturing. The photodetector 10 may be a photodetector without a filter, configured to transmit only in the visible wavelength range. Thus, it is possible to simplify the manufacture of the glazed element 1. The photodetector 10 may comprise a detector formed by a CMOS sensor and/or a CCD sensor. The photodetector 10 may be an imager formed by an array of pixels, each pixel comprising a CMOS sensor or a CCD sensor. Indeed, the above-mentioned photodetectors make it possible to detect a light beam having a visible wavelength and a wavelength in the near infrared.

The glazed element 1 may comprise a housing 14 configured to support a rearview mirror of the vehicle. The housing 14 is fixedly mounted to the first face F4. The photodetector 10 can be arranged in the housing 14. Thus, it is possible to detect a light beam passing through the set of points of the first face F4 without visually impeding the driver during the use of the vehicle.

### Light Absorption Layer 15 Forming a Pattern

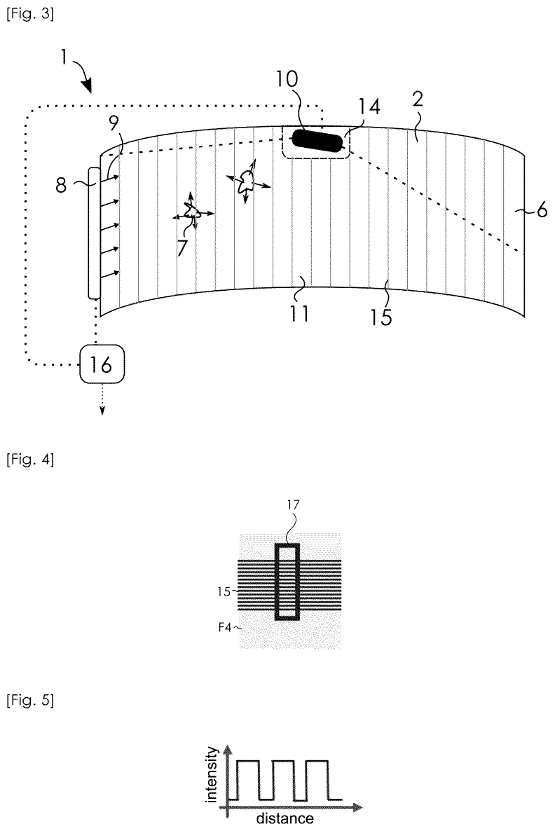

With reference to FIG. 3 and FIG. 4, the glazed unit 2 may comprise a light absorption layer 15. The light absorption layer 15 may be arranged on part of the first face F4, and preferably on at least part of the detection surface 11. The light absorption layer 15 forms a pattern on the first face F4, and preferably on the detection surface 11.

The light absorption layer 15 has a transmittance greater than 0.7, and preferentially greater than 0.9, for a light beam having a wavelength between 380 nm inclusive and 780 nm inclusive.

The light absorption layer 15 has a transmittance of less than 0.3, and preferentially less than 0.1, for a light beam having a wavelength between 780 nm exclusive and 2500 nm inclusive.

Thus, it is possible to detect a modification of the spatial distribution of the light intensity along a boundary of the pattern, without impeding the vision of the driver through the glazed unit 2. Indeed, the formation of condensation droplets 7 on the boundary of the pattern causes a scattering of the light beam 9, and thus a modification of the spatial distribution of the light intensity detected along this boundary. This makes it possible to detect the nucleation of a condensation droplet 7 with a detection limit smaller than the detection limit of the detectors of the prior art. The photodetector 10 may be an imager, configured to image the light intensity of the pattern.

The pattern may comprise parts having a width, relative to the main surface, of less than 1 cm, preferably less than 5 mm. Thus, it is possible to image several boundaries of the pattern during the formation of a single condensation droplet 7, which makes it possible to minimize the detection boundary of a condensation droplet 7 of the glazed element 1.

With reference to FIG. 3 and to FIG. 4, the pattern can form an array of strips on the detection surface 11. The strips may be parallel to one another. Thus, it is possible to minimize the boundary for detecting the nucleation of a condensation droplet 7 over the entire detection surface 11 covered by the array of strips.

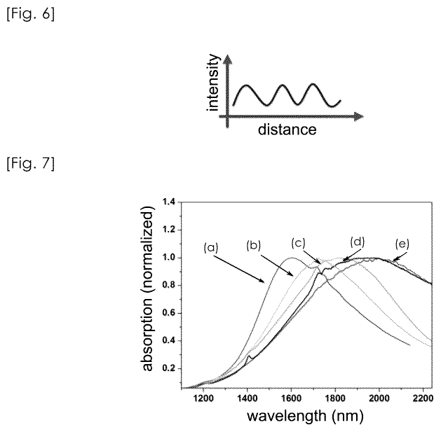

FIG. 4 shows a light absorption layer 15 forming an array of strips on the first surface F4, as well as a region of interest 17 comprising a part of the array of strips. FIG. 5 shows an intensity measured by the photodetector 10 along a segment passing through the region of interest 17 in the absence of condensation droplets 7 in the region of interest 17. FIG. 6 shows an intensity measured by the photodetector 10 along a segment passing through the region of interest 17 in the presence of condensation droplets 7 in the region of interest 17.

The light absorption layer 15 may be formed by a second material. The second material may be an electrically conductive and/or electrically semiconductive oxide. The second material may be indium-tin oxide. Thus, the second material may have the transmittance characteristics of the light absorption layer 15.

With reference to FIG. 7, the second material may be indium-tin oxide doped with at least one metal element and configured to have a maximum light absorption for a wavelength between 780 nm and 1000 nm. Indeed, the doping of the indium-tin oxide by a metal element makes it possible to adjust the wavelength for which the light absorption is maximum in the wavelength range of between 780 nm and 1000 nm. The morphology of grains forming the light absorption layer 15 also makes it possible to adjust the wavelength for which the light absorption is maximum in the wavelength range of between 780 nm and 1000 nm. The curves a), b), c), d) and e) shown in FIG. 7 correspond to light absorption layers 15 formed of indium-tin oxide and whose morphologies of the grains forming the light absorption layer 15 are each different from the others. The light absorption layer 15 may be deposited by sputtering.

1. A glazed element for a vehicle, comprising a glazed unit extending along a main surface, the glazed unit comprising a first glass sheet, the first glass sheet having a first face and a second face parallel to the main surface, the second face being opposite the first face relative to the first glass sheet, the glazed unit having a first edge and a second edge opposite the first edge, the first face being able to be in contact with an interior ambient environment of the vehicle and to support nucleation of a condensation droplet, the glazed element comprising:
a light source configured to emit a light beam, and a photodetector configured to detect the light beam emitted by the light source, the light source being arranged so that the light beam propagates in the first glass sheet from the first edge to the second edge by several total internal reflections on the first face and on the second face,
the photodetector being arranged outside the glazed unit and on a side of the first face relative to the first glass sheet,
the first face comprising a detection surface having a surface area greater than 0.01% inclusive of a total surface area of the first face,
the photodetector being configured to receive the light beam passing through at least part of the detection surface.

2. The glazed element according to claim 1, wherein the glazed unit is a laminated glazed unit, the glazed unit comprising a second glass sheet and an interlayer arranged between the first glass sheet and the second glass sheet, the second face being on a side of the interlayer relative to the first glass sheet, the first glass sheet being formed by a first glass having a first refractive index n₁, the glazed unit comprising a first material covering the second face on the side of the interlayer relative to the second face and having a second refractive index n₂, the second refractive index n₂ being strictly less than the first refractive index n₁.

3. The glazed element according to claim 2, wherein the first material covering the second face forms, at least in part, the interlayer.

4. The glazed element according to claim 2, wherein the first glass has a first absorption coefficient a₁ of the light beam, the second glass sheet being formed by a second glass, the second glass having a second absorption coefficient a₂ of the light beam, the first absorption coefficient a₁ being strictly less than the second absorption coefficient a₂.

5. The glazed element according to claim 1, wherein the light source extends along the first edge.

6. The glazed element according to claim 1, wherein the light beam has a wavelength between 780 nm inclusive and 2500 nm inclusive.

7. The glazed element according to claim 1, wherein the detection surface is defined by a part of the first face, the part running along an element selected from a lateral edge of the glazed unit, a lateral edge on the driver's side of the glazed unit, a lower lateral edge of the glazed unit, a corner of the glazed unit and a lower corner on the driver's side of the glazed unit.

8. The glazed element according to claim 1, wherein the photodetector has no filter configured to transmit a light beam having a wavelength only between 380 nm inclusive and 780 nm inclusive.

9. The glazed element according to claim 1, wherein the photodetector has a field of view, the arrangement of the photodetector and the field of view being configured so that the photodetector detects a light beam passing through the detection surface.

10. The glazed element according to claim 1, wherein the first edge is the lateral edge on the driver's side of the glazed unit.

11. The glazed element according to claim 1, comprising a housing configured to support a rearview mirror of the vehicle, the photodetector being arranged in the housing.

12. The glazed element according to claim 1, wherein the glazed unit comprises a light absorption layer arranged on a part of the first face, the light absorption layer forming a pattern on the first face, the light absorption layer having a transmittance greater than 0.7 for a wavelength range of between 380 nm inclusive and 780 nm inclusive, and having a transmittance of less than 0.3 for a wavelength range of between 780 nm exclusive and 1100 nm inclusive.

13. The glazed element according to claim 12, wherein the light absorption layer is formed by a second material, the second material being an electrically conductive and/or electrically semiconductive oxide.

14. The glazed element according to claim 12, wherein parts of the pattern have a width relative to the main surface of less than 1 cm.

15. The glazed element according to claim 12, wherein the pattern forms an array of strips on the detection surface.

16. The glazed element according to claim 13, wherein the second material is indium-tin oxide doped with at least one metal element and configured to have a maximum light absorption for a wavelength of between 780 nm and 1000 nm.

17. The glazed element according to claim 4, wherein the first absorption coefficient a₁ is less than 0.5 cm⁻¹.

18. The glazed element according to claim 5, wherein the light source extends from one corner of the glazed unit to another corner of the glazed unit.

19. The glazed element according to claim 12, wherein the light absorption layer has a transmittance greater than 0.9 for a wavelength range of between 380 nm inclusive and 780 nm inclusive and has a transmittance of less than 0.1 for a wavelength range of between 780 nm exclusive and 1100 nm inclusive.

20. The glazed element according to claim 13, wherein the second material is indium-tin oxide.
